(19) United States
(12) Patent Application Publication
(10) Pub. No.: US 2008/0244062 A1
(43) Pub. Date: Oct. 2, 2008

(54) Scenario based performance testing

(75) Inventors: Thirunavukkarasu Elangovan, Redmond, WA (US); Somesh Goel, Newcastle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/728,355

(22) Filed: Mar. 26, 2007

(51) Int. Cl. G06F 15/173; G06F 9/44

(52) U.S. Cl. 709/224; 717/115

(57) ABSTRACT

A framework for simulating user scenarios is provided in which actions defined by a script are automated and sent to a remote application in a terminal services environment. The scenarios may be created, modified, reused, or extended to a particular use case (i.e., a description of events used to achieve a product design goal) by reflecting different types of users, a combination of applications employed by such users, and characteristics associated with actions of the users. An automation engine is provided that interacts with one or more productivity applications through an object model. A scripting engine parses actions described by script (e.g., an XML (extensible Markup Language) script) and maps them to instructions sent to a corresponding component in the automation engine to be implemented through an interface with the application. The script establishes a profile schema that expresses the scenario.

### BACKGROUND

Testing is often a critical component in the development of successful products, including products implemented using software. Thoroughly tested products that meet the functional, performance, and usability expectations of customers generally stand the best chance of gaining a satisfied base of customers and a good market position. Developers who utilize well designed and implemented product testing plans can typically lessen the occurrence of quality failures and usability gaps in the end product.

Product developers often utilize product testing to identify defects early in the product development cycle in order reduce overall costs. Testing also can be used to push a product to its design limits in order to optimize or verify key performance factors such as response time, glitches (i.e., disruption in the provision of a feature or service), operating speeds, reliability, and extensibility/scalability.

To provide the most reliable and cost-effective results, it is generally accepted that product testing should be performed using repeatable methodologies that produce objective data. Unfortunately, current testing often relies on time-consuming and expensive manual methods. In addition, products are often tested against artificial or arbitrary benchmarks. For example, a popular performance benchmarking product, WinBench published by Ziff-Davis, employs a benchmark which relies on execution time of a fixed graphic task. Playback of GDI (Graphic Device Interface) calls are used for determining how efficient a remote display protocol performs when sending data to a client for display. While such benchmarking can indicate a relative change in performance of the protocol as its operating or design parameters are varied, it does not necessarily indicate actual performance of the product as deployed in the field.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A framework for simulating user scenarios is provided in which actions defined by a script are automated and sent to a remote application in a terminal services environment. The scenarios may be created, modified, reused, or extended to a particular use case (i.e., a description of events used to achieve a product design goal or function) by reflecting different types of users, a combination of applications employed by such users, and characteristics associated with actions of the users, such as typing rate, the speed of mouse movements or other input actions.

In an illustrative example, an automation engine is provided that interacts with one or more productivity applications through an object model. A scripting engine parses actions described by an XML (eXtensible Markup Language) script and maps them to instructions sent to a corresponding component in the automation engine to be implemented, through an interface such as an application object model or scripting interface, by the remote application. The XML script establishes a schema that expresses the scenario. The schema is divided into hierarchies which respectively define a scenario to be run, provide a mechanism for synchronizing events occurring during scenario runtime, and provide an automation context for the objects on which the automated actions are performed.

The present framework for scenario-based performance testing provides a number of advantages. By simulating actual user scenarios in combination with usage of real applications, optimizations and improvements may be designed and implemented by measuring their impact on the performance of terminal services as deployed, rather than relying on an arbitrary benchmark.

As an internal development tool, the framework enables terminal services and architectures to be thoroughly tested using a deterministic methodology that is repeatable, automated, and objective. Application developers can perform sensitivity analysis to see how one change in an application feature, implementation, or other parameter will affect overall end-to-end terminal services performance, and which particular user scenario has the greatest effect or presents the most concern (e.g., which scenario can cause unacceptable performance degradation or failure). New scenarios may readily be created or existing scenarios can be reused or extended to simplify the comparison of performance impacts between applications builds.

Alternatively, the framework enables administrators who support terminal services to perform capacity planning. Administrators can test their networks using automated actions in the scenarios to measure the impact of additional users, the rollout of new applications, or changes in network configuration on overall network latency or other performance metrics. Accordingly, planning may be performed to determine, for example, if new servers or user-licenses are needed. Or, if no changes are implemented, the impact expected from either a network or user perspective may be assessed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 is a diagram of an illustrative environment 100 supporting a terminal services session between a terminal server and a client computer;

FIG. 2 shows details of an illustrative basic RDP (Remote Desktop Protocol) architecture;

FIG. 3 depicts a group of one or more simulations of user actions that provide inputs to applications running on a terminal server;

FIG. 4 shows an illustrative class diagram of a automation engine and a scripting engine;

FIG. 5 shows additional components of the scripting engine shown in FIG. 4; and

FIG. 6 shows an illustrative example of a profile schema using an XML (eXtensible Markup Language) script.

### DETAILED DESCRIPTION

Terminal services provide functionality similar to a terminal-based, centralized host, or mainframe environment in which multiple terminals connect to a host computer. Each terminal provides a conduit for input and output between a user and the host computer. A user can log on at a terminal, and then run applications on the host computer, accessing files, databases, network resources, and so on. Each terminal session is independent, with the host operating system managing multiple users contending for shared resources.

The primary difference between terminal services and a traditional mainframe environment is that the terminals in a mainframe environment only provide character-based input and output. A remote desktop client or emulator provides a complete graphical user interface, including, for example, a Microsoft Windows® operating system desktop and support for a variety of input devices, such as a keyboard and mouse.

In the terminal services environment, an application runs entirely on the terminal server. The remote desktop client performs no local execution of application software. The server transmits the graphical user interface to the client. The client transmits the user's input back to the server.

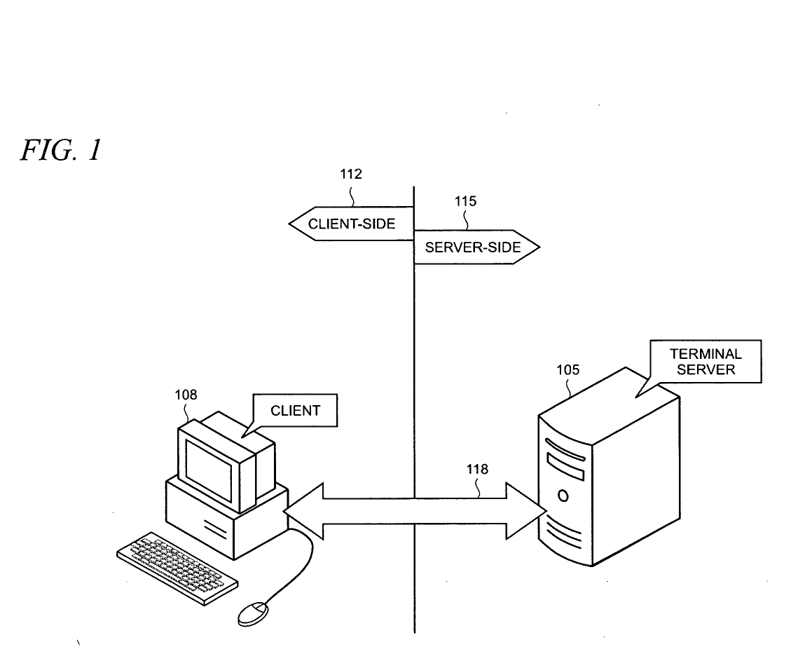

Turning now to the figures where like reference numerals indicate like elements, FIG. 1 is a diagram of an illustrative environment 100 supporting a terminal services session between a terminal server 105 and a client computer 108. Environment 100 is divided into a client-side and a server-side, respectively, as indicated by reference numerals 112 and 115. Terminal server 105 on the server-side 115 operatively communicates with the client computer 108 on the client-side 112 over a network 118 using a terminal services protocol. In this illustrative example, the terminal services protocol 118 is arranged to use a Remote Desktop Protocol (“RDP”) that typically operates over a TCP/IP (Transmission Control Protocol/Internet Protocol) connection between the client computer 108 and terminal server 105 on network 118.

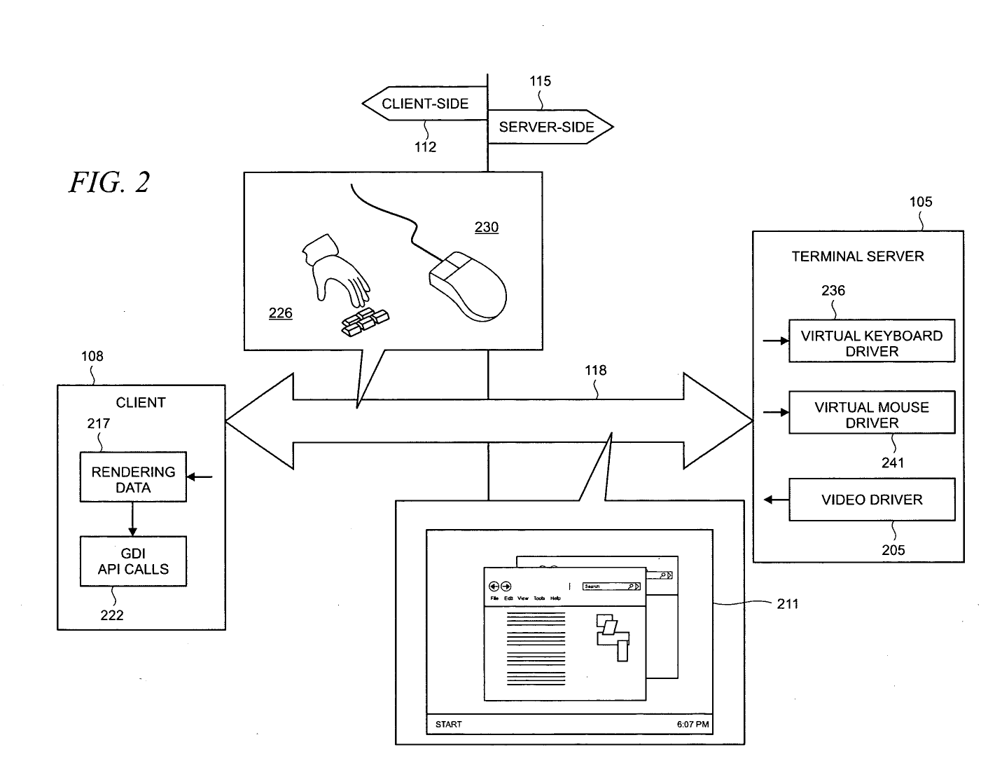

FIG. 2 shows details of a basic RDP architecture 200. On the server side 115, an RDP video driver 205 renders display output 211 by constructing the rendering information into network packets using the RDP protocol and sending them over the network 118 to the client 108. The display protocol is typically encrypted, generally in a bi-directional manner, although in some cases only data from the client 108 to the terminal server 105 is encrypted. Such encryption is utilized to prevent discovery of user's passwords and other sensitive information by “sniffing” the wire.

On the client-side 112, rendering data 217 is interpreted by the client 108 into corresponding GDI API (Application Programming Interface) calls 222. On an input path, client keyboard and mouse messages, 226 and 230 respectively, are redirected from the client 108 to the terminal server 105. On the server-side 115, the RDP architecture 200 utilizes its own virtual keyboard 236 and mouse driver 241 to receive and interpret these keyboard and mouse events.

In addition to the RDP components shown in FIG. 2, RDP architecture 200 typically utilizes one or more of a variety of mechanisms to optimize bandwidth usage over the network 118. For example, data compression and caching of bitmaps and glyphs is commonly used to improve performance, particularly over low bandwidth connections with applications that make extensive use of large bitmaps.

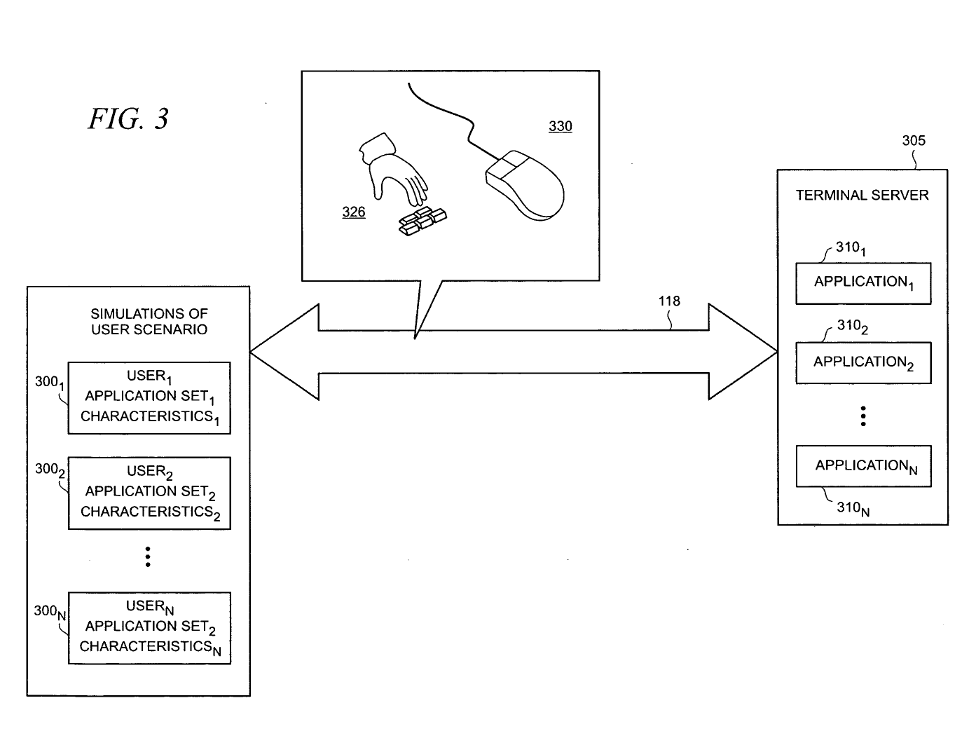

FIG. 3 depicts a group of one or more simulations of a user scenario 300-1, 2 . . . N that provides inputs to applications 310-1, 2 . . . N running on a terminal server 305. Each user scenario 300 provides a framework for testing the RDP protocol, discussed above in the text accompanying FIG. 1, by automating common applications to simulate (i.e., mimic) actions of a user. The simulated user actions provided by a scenario are used as inputs to the one or more of the applications 300 on the terminal server 305 to test the interaction between a user and the remote applications as well as the performance of the RDP architecture 200 (FIG. 2).

Applications 310 typically include office automation or productivity applications that are utilized in an enterprise environment including web browsing, word processing, presentation and graphics (e.g., drawing, flowcharting, etc.), database, spreadsheet, and email applications. One commercial embodiment of such applications includes the Microsoft Office® software suite. However, it emphasized that the present arrangement for scenario-based performance testing is not limited to just productivity applications that are commonly used in an office environment. Any type of application that may be configured to run in a terminal server environment can typically be automated to simulate a particular use case as may be required by a specific application of scenario based performance testing.

A scenario may be individualized for a particular use case and reflect different user types 1, 2 . . . N, application sets 1, 2 . . . N, and characteristics 1, 2 . . . N. For example, a novice user could be expected to use a different mix or combination of applications than used by a more advanced knowledge user, or an expert user. The novice user might only employ a word processing application, while the knowledge user employs both word processing and email. The expert user may use word processing, spreadsheet and email applications. The particular combination of applications associated with each particular user type may be varied as required by a specific application of scenario-based performance testing.

In addition, characteristics associated with the user, such as the speed of typing or mouse movements (or the speed of execution of any action or operation), can be varied by scenario. Thus, a particular scenario 300 may be created, modified, reused, or extended as required to test RDP which generates and sends keyboard and mouse events 326 and 330 to one or more of the applications 310 running on the terminal server 305. Through the application of one or more scenarios, the RDP architecture and its constituent components and techniques (for example, a bandwidth compression algorithm) can be tested in a time-saving automated and repeatable manner that reflects actual application use and not simply performance against an arbitrary benchmark.

Different scenarios can be formulated and used, for example, to test various components and/or aspects of the RDP architecture and associated network bandwidth optimization techniques. For example, a scenario comprising a set of actions is created and run over the RDP architecture shown in FIG. 2. A measurement of bandwidth consumed and time taken for each granular action is made to create a performance baseline. Individual changes are then made, for example by varying a data compression parameter. The same scenario is run again, and the same bandwidth and time measurements are taken to quantify the performance variation from the baseline. Thus, the present scenario-based performance testing provides a flexible and extensible framework to test RDP optimization techniques and their interaction with actual applications.

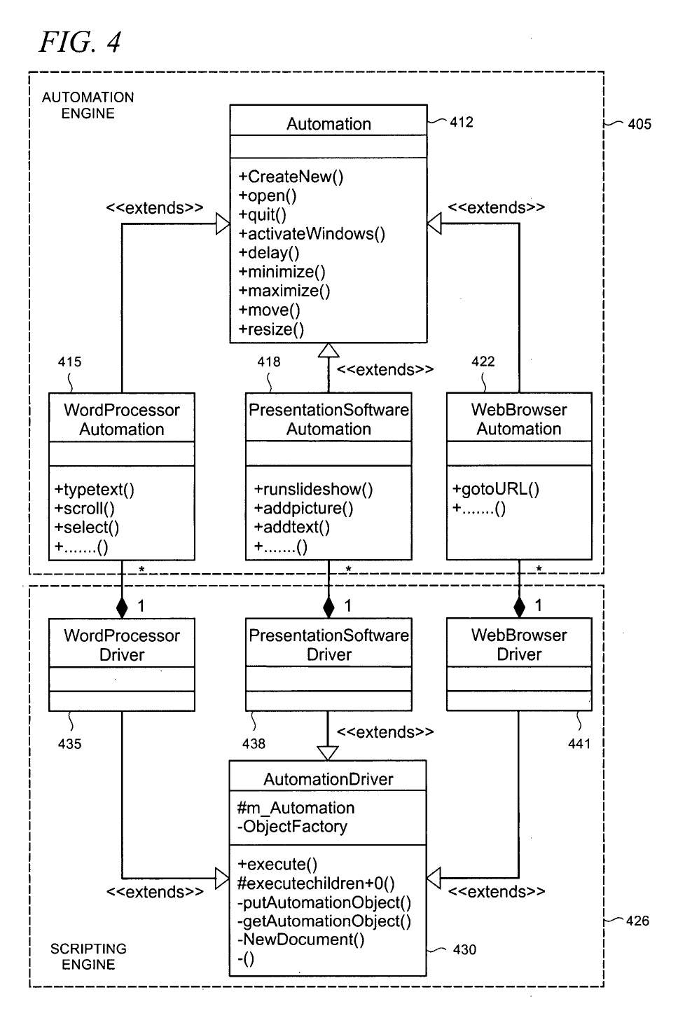

FIG. 4 shows an illustrative class diagram 400 in UML (Unified Modeling Language) of an automation engine 405 and a scripting engine 426. In an illustrative example, the automation engine 405 and scripting engine 426 are commonly arranged as scenario-based performance testing utility that can be alternatively arranged as a standalone application, application programming interface (API), or library that may be arranged to run on a client to thereby simulate actions, in the form of one or more scenarios, that could be performed by a user at a client computer.

The automation engine 405 includes an abstract automation class 412 that contains a number of actions (i.e., operations) that interact with an application, such as a productivity application, typically through the application's existing object model or scripting interface, or through an existing automated user interface. Such operations illustratively include file actions (e.g., creating new, open, quit, etc.), application actions (formatting, typing, selecting, etc.), and desktop actions (e.g., activate, minimize, maximize, etc.) that a user commonly performs when interacting with an application. Actual application functionality is thereby exposed through the interface with the object model to implement the automated actions.

In addition, by interacting with an application's object model, a high degree of scenario portability may be achieved where the automation provided does not lose functionality as new versions of applications are introduced. That is, a new application version may employ a new or different user interface but since that application's object model typically stays the same, automated actions provided by a scenario will still be valid for the classes, methods and properties provided by the object model.

As noted above, any of a variety of applications may be utilized as required for a specific instance of scenario-based performance testing. In this illustrative example, as shown in FIG. 4, the automation engine 405 includes components to support three productivity applications including word processing (WordProcessorAutomation 415), presentation creation and management (PresentationSoftwareAutomation 418), and web browsing (WebBrowserAutomation 422). WordProcessorAutomation 415 includes a variety of actions that a user typically applies when using a word processing application including typing, scrolling, selecting, etc. PresentationSoftwareAutomation 418 also includes typical presentation software actions such as running a slideshow, adding a picture, adding text, etc. Similarly, WebBrowserAutomation 422 includes typical web browsing actions such as navigating to a particular URL (Uniform Resource Locator). Thus, each component in the automation engine may invoke actions that are specific to its respective application.

The present scenario-based performance testing is extensible to other applications by the addition of other classes into the automation engine 405. Accordingly, automated actions for other applications, such as a media player or a portable document viewer, may be implemented using the present framework.

The scripting engine 426 is arranged to parse an automation script and map elements in the script to instructions sent to the automation engine 405 using an automation driver (AutomationDriver 430). AutomationDriver 430 is a base class to specific drivers associated with the applications used in this illustrative example (i.e., the word processor, presentation application, and web browser), as indicated by reference numerals 435, 438, 441, respectively. AutomationDriver 430 also implements common functionality such as storing and retrieving automation objects exposed by the applications' object model during a scenario runtime. The instructions are then implemented by the automation components in the automation engine 405 through manipulation of the appropriate application's object model to thereby perform the scripted actions.

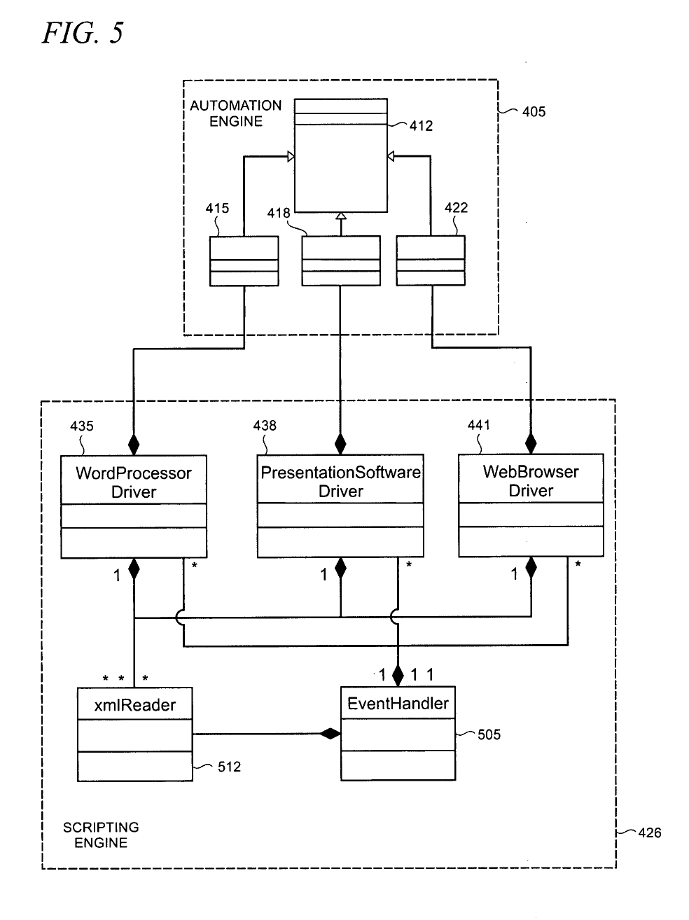

As shown in FIG. 5, the scripting engine 426 is further arranged to implement an eventing mechanism using an event handler 505. The other components in the scripting engine 426 are typically arranged with event listeners to thereby gather information about the automation state. For example, when a particular action is completed for one application, an action for another application is responsively invoked. Accordingly, the scripting engine 426 manages automation object lifetime state through the eventing mechanism.

Scripting engine 426, in this illustrative example, is arranged with an XML (eXtensible Markup Language) reader, shown as xmlReader 512 in FIG. 5. The use of XML enables scenarios to be readily created, modified, and extended using a profile schema that enables actions in the scenarios to be expressed. During scenario runtime, xmlReader 512 parses an XML script that expresses the scenario. In alternative implementations, other forms and structures may be used to express scenarios including executable code or libraries.

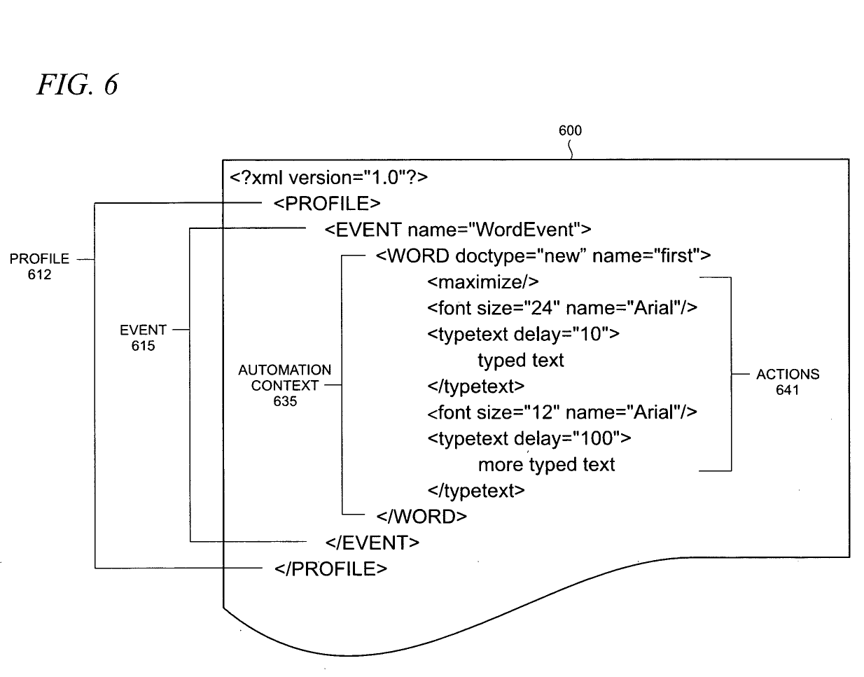

FIG. 6 shows an illustrative example of a profile schema using an XML script 600. This illustrative schema is arranged with three basic hierarchies, however the schema can be extended to support additional hierarchies as may be required by specific applications of the present scenario-based performance testing. The profile hierarchy 612 expresses and encapsulates the complete scenario to be run. The scenario is broken down into smaller subparts called events. Each event is typically used to mark the beginning and the end of a set of automated actions. Accordingly, the event hierarchy provides a synchronization mechanism to operate among the objects used in a given scenario so that automation state information may be collected and shared and responsive actions triggered (e.g., through the eventing mechanism described above in the text accompanying FIG. 5).

In this illustrative example, an event hierarchy 615 comprises an event associated with a word processing application. An automation context hierarchy 635 represents objects or entities on which the particular automated actions (indicated by reference numeral 641) are performed. Such objects or entities may be, for example, instances of applications such as word processing or web browsing, or global entities such as those associated with operating system features such as the desktop, or start menu, etc. As shown, the actions 641 performed in the automation context 635 include typical user actions such as increasing the font size and typing that are performed on a word processing automation object.

As noted above, characteristics associated with a particular user are modeled to enhance the realism of a particular scenario. Accordingly, the typetext element in the illustrative XML script 600 includes a delay attribute (that is dimensioned in units of seconds) to thereby associate a time delay with the particular text that is typed. Such an attribute may be used as one of the aspects for defining different user types, for example, novice user, knowledge user, expert user, etc. who may type or provide other inputs at different speeds. Other attributes may also be utilized as required by a specific application of scenario-based performance testing. For example, attributes for time or other parameters may be applied to mouse movements or other user inputs and actions.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-readable medium containing instructions which, when executed by one or more processors disposed in an electronic device, performs an automated method for performance testing of a terminal service session, the method comprising the steps of:
applying a scenario in which user interaction with a productivity application is simulated by scripted actions;
mapping the scripted actions to instructions that are arranged for automating the productivity application in accordance with the scenario;
implementing the instructions through manipulation of an interface to the productivity application; and
measuring performance of the terminal service session during the scenario's runtime.

2. The computer-readable medium of claim 1 in which the scripted actions are defined using an XML document having a hierarchical schema comprising at least one of profile hierarchy, event hierarchy, or automation context hierarchy, the profile hierarchy encapsulating the scenario, the event hierarchy marking a beginning and an end to a series of automated actions, and the automation context identifying an object on which an action is performed.

3. The computer-readable medium of claim 1 in which the interface is one of an application object model, an application scripting interface, or an automated user interface.

4. The computer-readable medium of claim 1 in which the terminal service session is operated over an RDP architecture comprising a terminal server and a client, the terminal server and client each being arranged to communicate over a network.

5. The computer-readable medium of claim 4 in which the measuring includes assessing bandwidth utilized on the network for a scripted action or assessing time required to complete implementation of a scripted action.

6. The computer-readable medium of claim 4 in which the method further includes steps of changing a terminal service session operating parameter, re-running the scenario, and re-measuring the performance to determine sensitivity of the RDP architecture to changing operating parameters.

7. The computer-readable medium of claim 1 in which the method further includes steps of applying another scenario and re-measuring the performance to identify a scenario that causes degradation in terminal services performance.

8. A computer-readable medium containing instructions which, when executed by one or more processors disposed in an electronic device, implements a utility for automating user actions received by one or more applications running in a terminal services environment, the utility comprising:
an automation engine arranged for interacting with the one or more applications using an interface, the automation engine carrying out automation instructions for implementing the user actions in the one or more applications; and
a scripting engine arranged for parsing a script and mapping elements in the script to the automation instructions, the script establishing a schema arranged for defining a scenario in which user interaction with the one or more applications is simulated.

9. The computer-readable medium of claim 8 in which the scripting engine includes one or more application drivers which provide the instructions to corresponding application automation components disposed in the automation engine.

10. The computer-readable medium of claim 9 in which the application automation components are mapped to respective applications and each application automation component defines actions that are specific to each of the respective applications.

11. The computer-readable medium of claim 8 in which the scripting engine further includes an eventing mechanism for sharing automation state information.

12. The computer-readable medium of claim 8 in which the schema is a profile schema comprising at least one event and an automation context, the at least one event defining a beginning and an end of a plurality of automated actions, and the automation context identifying an application object to which the plurality of automated actions are applied.

13. The computer-readable medium of claim 8 in which the one or more applications include productivity applications including at least one of word processor application, spreadsheet application, presentation application, graphics application, drawing application, flowchart application, email application, page layout application, database application, or web browser application.

14. The computer-readable medium of claim 8 in which the scenario is one of a plurality of scenarios, each of the scenarios being associated with a different user type.

15. The computer-readable medium of claim 14 in which of the different user type is defined by a unique combination of actions and applications utilized.

16. The computer-readable medium of claim 14 in which the different user type is defined by a characteristic selected from one of typing speed, mouse movement speed, or input action speed.

17. A method for performing capacity planning for a network, the network utilizing a terminal server and one or more clients, the method comprising the steps of:
running a scenario on the one or more clients, the scenario simulating user interaction with an application operating on the terminal server, the scenario defined by a script, the user interaction being implemented through manipulation of the application's object model in accordance with automation instructions that are generated by parsing the script;
measuring an impact of the running scenario on performance of the network, the performance being determined at least in part by latency of the simulated user interaction between the server and the one or more clients over the network; and
planning for network capacity in response to the measuring.

18. The method of claim 17 in which the script is implemented using one of XML, executable code, or library.

19. The method of claim 17 in which the network capacity is realized through utilization of additional user licenses associated with the application.

20. The method of claim 17 in which the network capacity is realized through utilization of additional servers on the network.
